(19) United States
(12) Patent Application Publication
(10) Pub. No.: US 2026/0291307 A1
(43) Pub. Date: Sep. 24, 2026

(54) ROTOR DESIGN FOR PERMANENT MAGNET MOTOR

(71) Applicant: Panasonic Intellectual Property Management Co., Ltd., Osaka (JP)

(72) Inventors: CHANDRA SUWANDI WIJAYA, Singapore (SG); RYO KAJITANI, Osaka (JP)

(21) Appl. No.: 19/083,486

(22) Filed: Mar. 19, 2025

(51) Int. Cl. H02K 1/276

(52) U.S. Cl. CPC H02K 1/276; H02K 2201/06

(57) ABSTRACT

A rotor (104) for an electric motor (100) is disclosed. The rotor includes a cylindrical body (106) having a first rotor end (104a), a second rotor end (104b), and an outer surface (108) extending between the first rotor end (104a), and the second rotor end (104b). Further, the rotor includes a plurality of slots (110) formed on the outer surface (108). Each of the plurality of slots (110) extends from the first rotor end (104a) along a length of the outer surface (108) at a predefined angle with respect to a rotational axis of the cylindrical body (106).

### TECHNICAL FIELD

The present disclosure relates to a field of an electric motor. More particularly, the present disclosure relates to an electric motor having a rotor with improved thermal efficiency.

### BACKGROUND

The information in this section merely provides background information related to the present disclosure and may not constitute prior art(s) for the present disclosure.

An electric motor is a device that converts electrical energy into mechanical energy. Further, depending on the type of electric current, the electric current can be a Direct Current (DC) or Alternating Current (AC) electric motor. The electric motor is composed of a stator and a rotor which is located on an inside in the radial direction of the stator and is provided in a rotatable manner with respect to the stator. The rotor includes a rotary shaft which is rotatable around a rotational axis. One of the main factors making a highly efficient electrical motor is the management of the thermal buildup of the electric motor.

In the current design, the electric motor has a limited capability of thermal management owing to insufficient airflow within the electric motor. Therefore, in cases, a prolonged continuous operation of the electric motor or at a high load condition will result in an overall increase in the temperature of the electric motor, that can reduce the efficiency and overall performance of the electric motor. Further, the rise in the temperature of the electric motor can also result in failure or damage to the other components such as the rotor of the electric motor.

Accordingly, there exists a need for an improved electric motor with an improved rotor that may address the limitations of conventional electric motors.

The drawbacks/difficulties/disadvantages/limitations of the conventional techniques explained in the background section are just for exemplary purposes and the disclosure would never limit its scope only such limitations. A person skilled in the art would understand that this disclosure and below mentioned description may also solve other problems or overcome the other drawbacks/disadvantages of the conventional arts which are not explicitly captured above.

### SUMMARY

This summary is provided to introduce a selection of concepts, in a simplified format, that are further described in the detailed description of the invention. This summary is neither intended to identify key or essential inventive concepts of the invention nor intended to determine the scope of the invention.

In an embodiment of the present disclosure, a rotor for an electric motor is disclosed. The rotor includes but is not limited to a cylindrical body having a first rotor end, a second rotor end, and an outer surface that extends between the first rotor end and the second rotor end. The rotor further includes a plurality of slots formed on the outer surface. In an embodiment, each of the plurality of slots extends from the first rotor end along a length of the outer surface at a predefined angle with respect to a rotational axis of the cylindrical body.

In another embodiment of the present disclosure, an electric motor is disclosed. The electric motor includes a stator. Further, the electric motor includes a rotor installed radially inside the stator. The rotor includes a cylindrical body having a first rotor end, a second rotor end, and an outer surface extending between the first rotor end and the second rotor end. The rotor further includes a plurality of slots formed on the outer surface. In an embodiment, each of the plurality of slots extends from the first rotor end along a length of the outer surface at a predefined angle with respect to a rotational axis of the cylindrical body.

The rotor of the present disclosure enables the generation of constant axial airflow within the electric motor when the rotor rotates. The generation of the axial airflow promotes continuous air circulation within an air gap between the stator and the rotor, which helps to regulate the temperature of the electric motor and improves the thermal efficiency of the electric motor.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a perspective view of an exemplary electric motor, in accordance with an embodiment of the present disclosure;

FIG. 2 illustrates a perspective view of an exemplary rotor of the electric motor, in accordance with an embodiment of the present disclosure;

FIG. 3A illustrates the exemplary rotor depicting a formation of an exemplary slot at a predefined angle, in accordance with an embodiment of the present disclosure;

FIG. 3B illustrates the exemplary rotor depicting the slot having different sections with varying angles with respect to a rotational axis of the rotor, in accordance with an embodiment of the present disclosure;

FIG. 3C illustrates the exemplary rotor depicting the slot formed at the predefined angle continuously varying along a length of the rotor, in accordance with an embodiment of the present disclosure;

FIGS. 4A-4B illustrate exemplary cross-sectional shapes of a plurality of slots of the rotor, in accordance with an embodiment of the present disclosure;

FIG. 5 illustrates an outer surface of the rotor having the plurality of slots of varying depth, in accordance with an embodiment of the present disclosure;

FIG. 6A illustrates the exemplary rotor having the slot of varying depth along a length of a cylindrical body, in accordance with an embodiment of the present disclosure;

FIG. 6B illustrates the exemplary rotor having the slot with a tapered cross-section, in accordance with an embodiment of the present disclosure;

FIGS. 7A-7C illustrate exemplary side views of the rotor depicting a symmetric arrangement of the plurality of slots, in accordance with an embodiment of the present disclosure;

FIG. 8A illustrates the exemplary rotor depicting the slot having different shapes at both ends, in accordance with an embodiment of the present disclosure; and

FIG. 8B illustrates the exemplary rotor depicting the slot extending from a first rotor end to a centre of the rotor, in accordance with an embodiment of the present disclosure.

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” “one or more elements” “at least one feature” or “at least one element.” Furthermore, the use of the terms “one or more” or “at least one” feature or element does NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility, and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “a further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any feature and/or element described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

Embodiments of the present disclosure will be described below in detail with reference to the accompanying drawings.

Further, skilled artisans will appreciate those elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

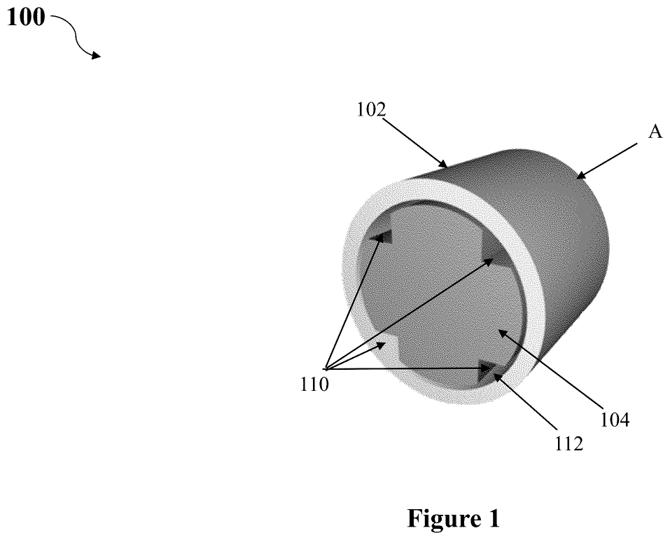

FIG. 1 illustrates a perspective view of an exemplary electric motor 100, in accordance with an embodiment of the present disclosure. In an embodiment, the electric motor 100 is a device that converts electrical energy into mechanical energy. The electric motor 100 works on the principle of electromagnetism. In a non-limiting example, the electric motor 100 may include but is not limited to a direct current (DC) motor, an alternating current (AC) motor, a synchronous motor, and an induction motor. The electric motor 100 may be widely used in various small appliances such as fans and vacuum cleaners, or large appliances such as conveyor belts and pumps.

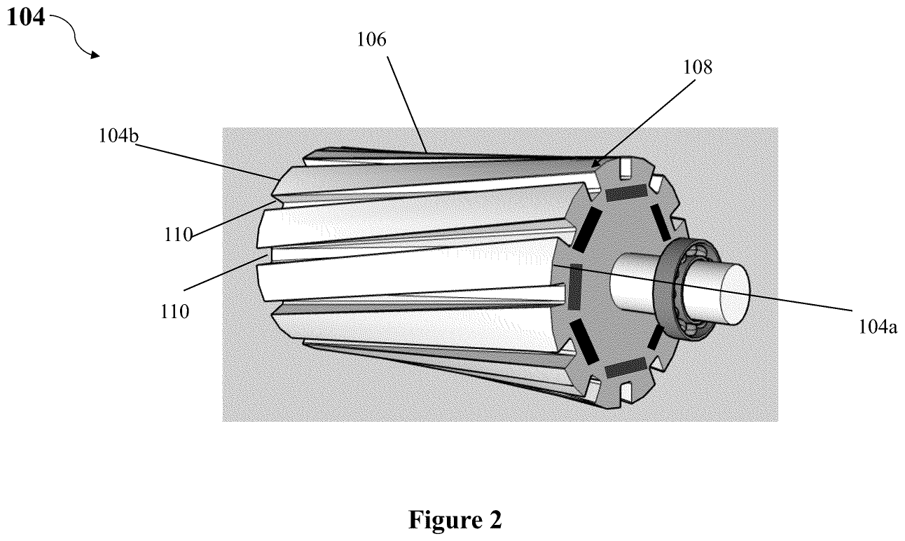

In an embodiment, the electric motor 100 may include stator 102. In an exemplary embodiment, the electric motor 100 may include a housing that may include the stator 102. The electric motor 100 may further include a rotor 104 that may be installed radially inside the stator 102. The rotor 104 may work in conjunction with the stator 102 to convert electric energy into mechanical energy. In an embodiment, the rotor 104 may include a cylindrical body 106 that may include a plurality of slots 110 which are discussed in conjunction with FIG. 2.

FIG. 2 illustrates a perspective view of the rotor 104 of the electric motor 100, in accordance with an embodiment of the present disclosure. In an embodiment, the cylindrical body 106 of the rotor 104 may include a first rotor end 104a. In an embodiment, the first rotor end 104a may herein refer to an end where electrical connections or bearings may be located. In another embodiment, other components of the electrical motor may also be located.

In an embodiment, the rotor 104 may further include a second end located distal to the first rotor end 104a. The second rotor end 104b may also herein referred to as an opposite end of the first rotor end 104a. In an embodiment, the first rotor end 104a and the second rotor end 104b may contribute to the rotor's stability and interaction with a magnetic field of the stator 102 to produce rotational motion.

In an embodiment, the rotor 104 may have an outer surface 108 that may be extended between the first rotor end 104a and the second rotor end 104b. In an embodiment, the rotor 104 may include the plurality of slots 110 formed on the outer surface 108. In an embodiment, each of the plurality of slots 110 may extend from the first rotor end 104a along a length of the outer surface 108 at a predefined angle with respect to a rotational axis of the cylindrical body 106. In an advantageous effect, the plurality of slots 110 may be designed in such a way as to generate air within the electric motor 100.

In another embodiment, the plurality of slots 110 may also be adapted to allow airflow therethrough. In an embodiment, the plurality of slots 110 may also receive outside air (A) which may increase the percentage of air flowing inside the electric motor 100, which may lead to improved thermal efficiency of the electric motor 100.

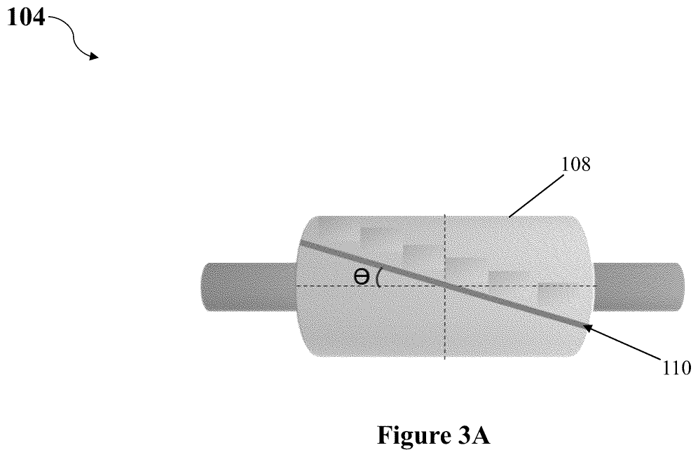

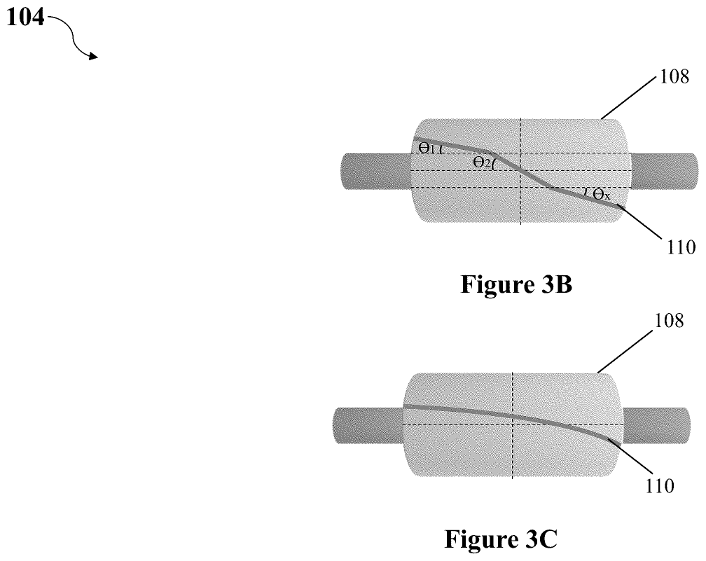

In one embodiment, the plurality of slots 110 may extend at the predefined angle with respect to a rotational axis of the rotor 102. Further, the predefined angle may vary corresponding to the length of the cylindrical body 106. In an embodiment, the predefined angle “θ” may be equal to an angle formed by a plurality of skewed magnets of the electric motor 100 as illustrated in FIG. 3A. In an advantageous effect, when when the rotor 104 may be in rotational motion, the rotor 104 may simultaneously generate constant axial airflow and promote continuous air circulation within an air gap 112 to improve a thermal regulation of electric motor 100.

In another embodiment, the predefined angle may be less than or greater than the angle formed by the plurality of skewed magnets of the electric motor 100 with respect to the rotational axis of the cylindrical body 106.

In yet another embodiment, the slot 110 may have different sections such that each of the sections may have varying angles with respect to the rotational axis of the rotor as illustrated in FIG. 3B. In this configuration, the formation of the slot 110 may not be dependent on the angle formed by the plurality of skewed magnets. In an exemplary scenario, the angle the slot 110 varies at θ₁, θ₂, θₓ at different sections along the length of the rotor 104 as illustrated in FIG. 3B. For example, the angle of the slot 110 along the length of the rotor 104 is shown in equations 1 and 2 below:

$${0}^{∘} < {θ}_{1} , {θ}_{2} , … {θ}_{x} < 9 {0}^{∘} \qquad ( 1 )$$

$$9 {0}^{∘} < {θ}_{1} , {θ}_{2} , … {θ}_{x} < 18 {0}^{∘} \qquad ( 2 )$$

Where θ₁≠θ₂≠ . . . ≠θₓ

FIG. 3C illustrates the rotor 104 depicting the formation of the slot 110 having the predefined angle continuously varying along the length of the rotor 104, in accordance with an embodiment of the present disclosure. In an exemplary embodiment, the angle of the slot 110 varies continuously such that the slot 110 is forming a curve shape along the length of the rotor 104.

In an embodiment, a shape of the plurality of slots 110 along the length may be symmetric in nature. In another embodiment, the shape of the plurality of slots 110 may be asymmetric in nature. In another embodiment, the shape of each of the plurality of slots 110 may be different or similar. In an embodiment, the shape of the plurality of slots 110 may be dependent on a type and size of the electric motor 100, a number of magnets used in the electric motor 100, or the like.

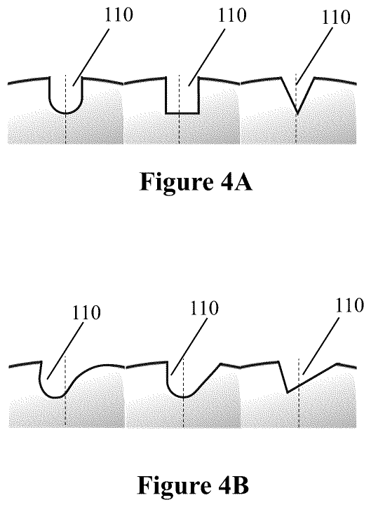

FIG. 4A illustrates exemplary cross-sectional shapes of the plurality of slots 110, in accordance with an embodiment of the present disclosure. In an embodiment, the plurality of slots 110 may have symmetric shapes FIG. 4B illustrates exemplary another cross-sectional shapes of the plurality of slots 110, in accordance with an embodiment of the present disclosure. In an embodiment, the plurality of slots 110 may have asymmetric shapes. In an exemplary embodiment, the asymmetric shapes of the plurality of slots 110 may enable generation of maximum airflow within the electric motor 100 while minimizing the impact of the magnetic flux density associated with the electric motor 100.

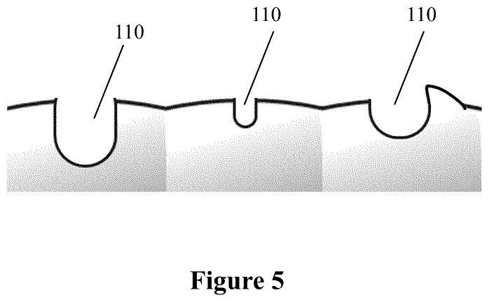

FIG. 5 illustrates the outer surface 108 of the rotor 104 having the slots 110 of varying depth, in accordance with an embodiment of the present disclosure. In an embodiment, a depth of the plurality of slots 110 may remain constant along the length of the slot 110. In another embodiment, the depth of the plurality of slots 110 may vary along the length of the slot 110. In an embodiment, the depth of the plurality of slots 110 may be optimized in such a way that a balance may be created between the generation of airflow and airflow loss.

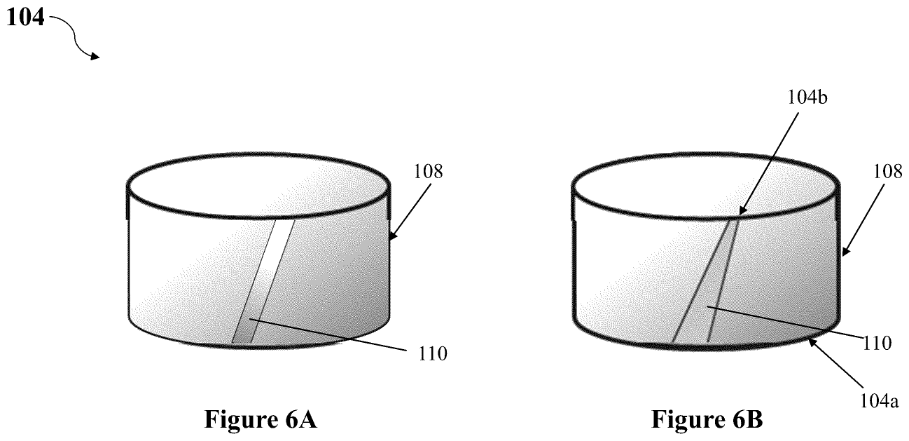

FIG. 6A illustrates the exemplary rotor 104 having the slot 110 of varying depth along the length of the cylindrical body 106, in accordance with an embodiment of the present disclosure. For example, the depth of the slot 110 at one point is 5 mm and at another point, the depth of the slot is 7 mm. In an advantageous effect, high depth of the slot 110 may result in more airflow generation within the electric motor 100. More specifically, the varying depth of the plurality of slots 110 may affect amount of the airflow up to a certain degree. In an advantageous effect, the performance such as torque, ripple, etc of the electric motor 100 may be improved.

FIG. 6B illustrates the exemplary rotor 104 having the slot 110 with a tapered cross-section, in accordance with an embodiment of the present disclosure. In another embodiment, the size of the plurality of slots 110 may vary along the length of the slot 110. For instance, the width of the plurality of slots 110 may vary along the length of the slot 110. For example, the slot 110 has the width of 10 mm at the first rotor end 104a and the width of 3 mm at the second rotor end 104b. In an advantageous effect, the airflow in the rotor 104 may increase or decrease due to varying width of the plurality of slots 110.

In various embodiments, a direction of the airflow may get change depending on a direction of a rotation of the rotor 104. Therefore, the plurality of slots 110 with varying width may increase or decrease a rate of the airflow depending on the direction of the air flow.

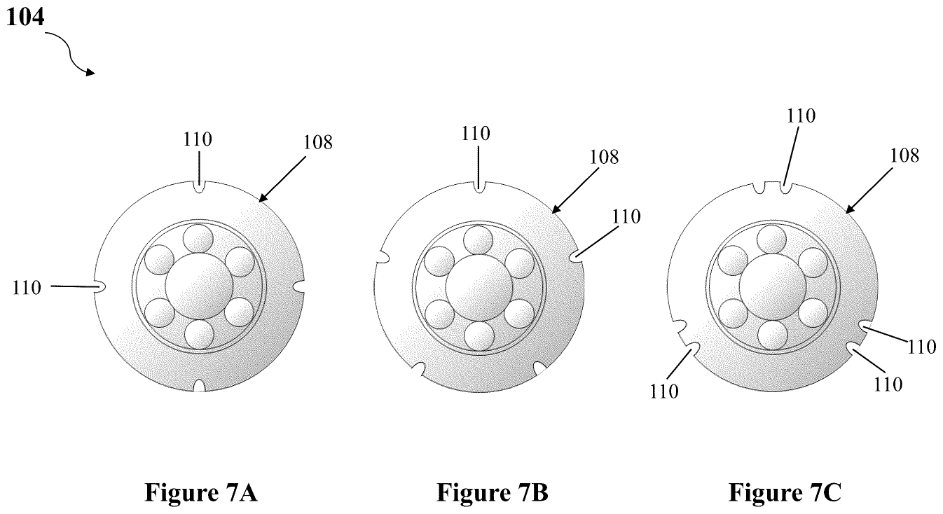

FIGS. 7A-7C illustrate exemplary side views of the rotor 104 depicting a symmetric arrangement of the plurality of slots 110, in accordance with an embodiment of the present disclosure. Referring to FIG. 7A, the outer surface 108 may include four slots 110 that are symmetrically spaced and radially apart from each other by a predetermined gap. In an exemplary embodiment, the four slots 110 are angular separated at an angle of 90°, which may be effective for the electric motor 100 of small size. In an advantageous effect, the number of slots 110 formed is sufficient to regulate the heat within the electric motor 100 of the small size. In various embodiments, the rotor 104 may include any number of slots 110 and may arranged in such a manner that the plurality of slots 110 may maintain radial symmetry.

Further, referring to FIG. 7B, the outer surface 108 may include five slots 110, and adjacent slots 110 may be formed at an equidistant, thereby maintaining radial symmetry of the plurality of slots 110. In an exemplary embodiment, the five slots 110 are angularly separated at an angle of 72°, which may be effective for the electric motor 100 of medium size. In an advantageous effect, the five slots 110 formed are sufficient to regulate the heat within the electric motor 100 of the medium size.

Furthermore, referring to FIG. 7C, the outer surface 108 may include three pairs of slots 110. In an embodiment, each pair of slots 110 is formed at the predetermined gap from the other pair of slots 110, thereby maintaining the radial symmetry of the plurality of slots 110. In an exemplary embodiment, the each pair of slots 110 is angularly separated at an angle of 120°, which may be effective for the electric motor 100 of large size. In an advantageous effect, the radial symmetry of the slots 110 may be effective for the electric motor 100 of the large size.

In various embodiments, the slots 110 may be formed in such a way that the slots 110 may form the radial symmetry, which may result in the maximum generation of the airflow and minimize the magnetic flux density of the electric motor 100.

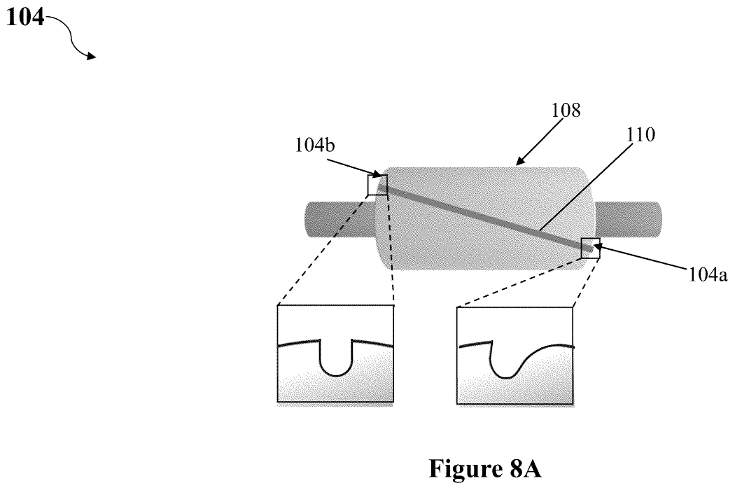

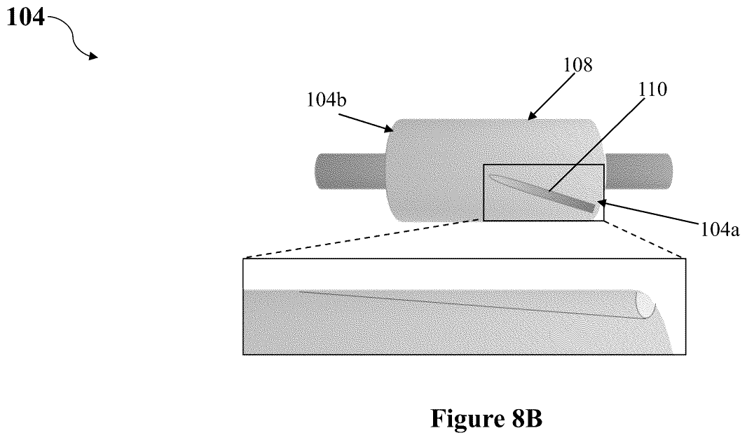

FIG. 8A illustrates the exemplary rotor 104 depicting the slot 110 having different shapes at both ends, in accordance with an embodiment of the present disclosure. In an enhanced view of the first rotor end 104a and the second rotor, the slot 110 has the asymmetric shape at the first rotor end 104a and the symmetric shape at the second rotor end 104b. As illustrated in the enhanced view, the slot 110 is formed in a U-shape at the second rotor end 104b. On the other hand, the slot 110 is formed in a curve shape at the first rotor end 104a. In an advantageous effect, the curve-shaped slot 110 may allow movement of the airflow in a particular direction and the U-shaped slot 110 may allow movement of the airflow in a uniform area, which results in improved cooling within the electric motor 100. In various embodiments, the rotor 104 may include the slots 110 that may be of any shapes and may arranged in such a manner that the plurality of slots 110 may maintain radial symmetry.

FIG. 8B illustrates the exemplary rotor 104 depicting the slot 110 extending from the first rotor end 104a to a centre of the rotor, in accordance with an embodiment of the present disclosure. In an enhanced view, the slot 110 is of asymmetric shape and ends at the centre of the rotor 104. In another embodiment, the slot 110 may be formed at any point of the outer surface and end at any point of the outer surface 108. In advantageous effect, the slot 110 may be formed at the area where the heat is generated due to the working of the components of the electric motor 100.

The present disclosure enables the generation of constant axial airflow within the electric motor 100 when the rotor 104 rotates. The generation of the axial airflow promotes continuous air circulation within an air gap 112 between the stator 102 and the rotor 104, which helps to regulate the temperature of the electric motor 100 and improves the thermal regulation of the electric motor 100. In an advantageous effect, the operating life of the electric motor 100 may be increased, and the working efficiency of the electric motor 100 may be improved.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A rotor for an electric motor, the rotor comprising:
a cylindrical body having a first rotor end, a second rotor end, and an outer surface extending between the first rotor end and the second rotor end; and
a plurality of slots formed on the outer surface, wherein each of the plurality of slots extends from the first rotor end along a length of the outer surface at a predefined angle with respect to a rotational axis of the cylindrical body.

2. The rotor of claim 1, wherein a shape of the plurality of slots along the length is one of a symmetric and an asymmetric.

3. The rotor of claim 1, wherein each of the plurality of slots are symmetrically spaced and radially apart from each other by a predetermined gap.

4. The rotor of claim 1, wherein a depth of each of the plurality of slots comprises one of remains constant and changes along the length of the plurality of slots.

5. The rotor of claim 1, wherein a size of each of the plurality of slots comprises one of remains constant and changes along the length of the plurality of slots.

6. The rotor of claim 1, wherein the predefined angle varies corresponding to the length of the cylindrical body.

7. The rotor of claim 1, wherein the predefined angle is one of equal, less, and greater to an angle formed by a plurality of skewed magnets of the electric motor with respect to the rotational axis of the cylindrical body.

8. An electric motor comprising:
a stator;
a rotor installed radially inside the stator, wherein the rotor comprises:
a cylindrical body having a first rotor end, a second rotor end, and an outer surface extending between the first rotor end and the second rotor end; and
a plurality of slots formed on the outer surface, wherein each of the plurality of slots extends from the first rotor end along a length of the outer surface at a predefined angle with respect to a rotational axis of the cylindrical body.

9. The electric motor of claim 8, wherein a shape of the plurality of slots along the length is one of a symmetric and an asymmetric.

10. The electric motor of claim 8, wherein each of the plurality of slots are symmetrically spaced and radially apart from each other by a predetermined gap.

11. The electric motor of claim 8, wherein a depth of each of the plurality of slots comprise one of remains constant and changes along the length of the plurality of slots.

12. The electric motor of claim 8, wherein a size of each of the plurality of slots comprise one of remains constant and changes along the length of the plurality of slots.

13. The electric motor of claim 8, wherein the predefined angle varies corresponding to the length of the cylindrical body.

14. The electric motor of claim 8, wherein the predefined angle is one of equal, less, and greater to an angle formed by a plurality of skewed magnets of the electric motor with respect to the rotational axis of the cylindrical body.
